(19) United States
(12) Patent Application Publication
(10) Pub. No.: US 2017/0037186 A1
(43) Pub. Date: Feb. 9, 2017

(54) COMPOSITION AND METHOD FOR A COMPOSITE MATERIAL IMPREGNATED WITH REACTIVE COMPOSITION OF A POLYAMIDE PREPOLYMER AND A DIEPOXIDE CHAIN EXTENDER

(71) Applicant: Arkema France, Colombes (FR)

(72) Inventors: Gilles Hochstetter, L'hay Les Roses (FR); Thierry Briffaud, Beernay (FR); Mathieu Capelot, Bernay (FR)

(73) Assignee: Arkema France, Colombes (FR)

(21) Appl. No.: 15/304,620

(22) PCT Filed: Apr. 15, 2015
(86) PCT No.: PCT/FR2015/051021

§ 371 Date: Oct. 17, 2016

(30) Foreign Application Priority Data
Apr. 15, 2014 (FR) 14 53353

(51) Int. Cl. C08G 69/48; C08J 5/04

(52) U.S. Cl. CPC C08G 69/48; C08J 5/04; C08J 2377/00

(57) ABSTRACT

A reactive molding composition including a precursor reactive composition of a semi-crystalline thermoplastic polymer which is a semi-crystalline polyamide and optionally at least one fibrous reinforcement and with said precursor composition including a) at least one polyamide prepolymer bearing n identical functions X chosen from carboxyl and amine and b) at least one non-polymeric extender bearing two epoxy functions Y that are reactive with said functions X with n ranging from 1 to 3, said polymer and prepolymer a) being of specific composition comprising 55 mol % to 95 mol % of at least two amide units A, and 5 mol % to 45 mol % of amide units B with A corresponding to x.T in which x is a linear aliphatic C9-C18 diamine and B corresponding to x′.T, said polyamide having a Tg of at least 80° C. and a Tm of less than or equal to 280° C.

The invention relates to a reactive molding composition, in particular for a thermoplastic composite material with a thermoplastic matrix made of semicrystalline polyamide (PA) having a glass transition temperature Tg of at least 80° C., preferably of at least 90° C., and a melting point Tm of less than or equal to 280° C., and also to a process for manufacturing said composite material, in particular mechanical or structural parts based on said composite material, to the use of the composition of the invention for parts made of composite material and also to the composite part which results therefrom and for applications in the motor vehicle, railway, marine, road transport, wind power, sport, aeronautical and aerospace, construction, panel and leisure fields.

EP 0 261 020 describes the use of reactive semi-crystalline prepolymers based on PA 6, 11 and 12 for the manufacture of a thermoplastic composite by means of a pultrusion process. The prepolymers of aliphatic structure as described have low Tg values and insufficient mechanical performance qualities at elevated temperature.

EP 550 314 describes, among its examples, (non-reactive) copolyamide compositions in a search for high melting points and limited Tg values, with the majority of the cited examples having an excessively low Tg (<80° C.) or an excessively high Tm (>300° C.).

EP 1 988 113 describes a molding composition based on a 10T/6T copolyamide with:
40 to 95 mol % of 10T
5 to 40 mol % of 6T.

Polyamides with a high melting point above 270° C. are targeted in particular. The examples mentioned and FIG. 1 teach that the melting point of these compositions is at least 280° C.

WO 2011/003 973 describes compositions comprising 50 mol % to 95 mol % of a unit based on a linear aliphatic diamine comprising from 9 to 12 carbon atoms and terephthalic acid and from 5% to 50% of units combining terephthalic acid with a mixture of 2,2,4- and 2,4,4-trimethylhexanediamine.

US 2011306718 describes a process for the pultrusion of low-Tg reactive aliphatic polyamides combined with chain extenders having a polymeric structure bearing several (and much more than 2) anhydride or epoxide functions. This document does not describe any non-polymeric extender.

The drawbacks of the prior art with the absence of a good compromise between the mechanical performance and the processability (ease of transformation) at lower temperature with a shorter production cycle time are overcome by the solution of the present invention which targets reactive molding compositions for a semi-crystalline PA, allowing easier processing at lower temperatures with a saving on the overall energy balance for the processing process, a shorter production cycle time and improved efficiency via rapid crystallizability of said polyamide polymer while at the same time maintaining a high level of mechanical performance for said final materials. More particularly, in the case of these reactive compositions, it is sought to have faster reaction kinetics while at the same time having a rate and/or temperature of crystallization of the polymer formed that are also higher.

The choice of a semi-crystalline polyamide polymer, as matrix of the composite material of the invention, has the advantage, compared with amorphous polyamides, of significantly improved mechanical performance levels, especially at elevated temperature, such as creep resistance or fatigue resistance. In addition, having a melting point above 200° C. has the advantage in the motor vehicle industry of being compatible with treatments by cataphoresis, which a structure of amorphous PA type does not permit. As for amorphous materials, a Tg of greater than or equal to 80° C., preferably at least 90° C. and more preferentially greater than 100° C., is sought so as to ensure good mechanical properties for the composite over the entire working temperature range, for example up to 80° C., preferably up to 90° C. for the wind power sector, up to 100° C. for the motor vehicle sector and up to 120° C. for the aeronautics sector. Conversely, a melting point that is too high, in particular above 280° C., is on the other hand detrimental since it requires processing of the composite at higher temperatures with constraints in terms of molding material to be used (and associated heating system) and overconsumption of energy with, in addition, risks of heat degradation due to heating at temperatures higher than the melting temperature of said polyamide, with, as a consequence, an effect on the properties of the final thermoplastic matrix and of the composite which results therefrom. The crystallinity of said polymer, i.e. of the final matrix polymer, must be as high as possible, but with a melting point Tm that is not too high, i.e. Tm 280° C. and more particularly 270° C., to allow optimum mechanical performance and a crystallization rate and/or crystallization temperature that are as high as possible, with reduction of the molding time before injection of the molded composite part and with a selective choice of the composition of said semi-crystalline polyamide. Consequently, the subject of the present invention is the processing of novel specific compositions of thermoplastic composite, in particular based on semi-crystalline polyamide, having a good compromise between high mechanical performance levels (mechanical strength), in particular at elevated temperature, and easy processing. The aim is to have compositions that are easy to process with transformation and processing temperatures that are lower than those for other compositions of the prior art, with a more favorable overall processing energy balance, a shorter cycle time and higher productivity. More particularly, the solution of the invention, in the case of these reactive compositions, allows, using compositions based on semi-crystalline reactive polyamide prepolymers, both fast reaction kinetics and fast crystallization kinetics with a shorter cycle time. In particular, the polyamide polymer matrix, while having a high Tg and a limited Tm as defined above, with easy processing of said composite, must also have a high crystallization rate, characterized first by a difference between the melting point and the crystallization temperature Tm−Tc not exceeding 50° C., preferably not exceeding 40° C. and more particularly not exceeding 30° C. More preferentially, this difference Tm−Tc does not exceed 30° C., unless Tm−Tg is <150° C., in which case (Tm−Tg<150° C.), the difference Tm−Tc may range up to 50° C. The mechanical performance or mechanical strength at elevated temperature of the composite may be evaluated by the variation of the mechanical modulus between room temperature (23° C.) and 100° C. with maintenance of at least 75% of the mechanical performance, in terms of modulus, relative to that at room temperature (23° C.). Thus, the object of the invention is to develop a polyamide-based reactive molding composition that satisfies these needs.

Thus, the first subject of the invention concerns a specific reactive molding composition, in particular for a thermoplastic composite material, this composition comprising a specific precursor reactive composition of a semi-crystalline thermoplastic polymer which is a semi-crystalline polyamide (PA) and, optionally, said molding composition comprises at least one fibrous reinforcement which, in this case, is preferably based on long fibers, said precursor reactive composition comprising at least one polyamide prepolymer that is reactive between and at least one polyaddition-mediated chain extender which bears epoxy functions that are reactive with the functions of said polyamide prepolymer. Said specific composition is based on the selective choice of at least two different amide units A and B in specific molar proportions, with the optional presence of at least a third (C) and optionally a fourth (D) amide unit, these units being different from each other.

A second subject of the invention relates to a specific process for manufacturing said thermoplastic composite material and more particularly for manufacturing mechanical parts or structural parts based on said composite material.

The invention also relates to the specific precursor reactive composition of the semi-crystalline PA of the invention and to the use thereof for the manufacture of a thermoplastic composite material and more particularly of mechanical or structural parts based on this material.

The invention also relates to the parts or articles and the thermoplastic composite material which results from said molding composition or from the precursor composition.

The first subject of the invention thus relates to a reactive molding composition, in particular for a thermoplastic composite material, this composition comprising a precursor reactive composition of a semi-crystalline thermoplastic polymer which is a semi-crystalline polyamide and optionally at least one fibrous reinforcement which, in this case (presence of fibrous reinforcement), is preferably based on long fibers and with:
said precursor reactive composition of said polyamide thermoplastic polymer comprising:
   a) at least one thermoplastic polyamide prepolymer, bearing n identical reactive end functions X, chosen from: —NH₂ and —CO₂H, preferably —CO2H, with n being from 1 to 3, preferably from 1 to 2, more preferentially 1 or 2, more particularly 2, and
   b) at least one chain extender Y-A′-Y, with A′ being a single bond linking the two functions Y or a hydrocarbon-based diradical of non-polymeric structure, bearing 2 reactive epoxy end functions Y, reactive by polyaddition with at least one function X of said prepolymer a), said extender b) preferably having a molecular mass of less than 500, more preferentially less than 400,
      and with
said semi-crystalline polyamide polymer derived from the polyaddition reaction between said components a) and b) of said precursor composition having a glass transition temperature Tg of at least 80° C. and preferably of at least 90° C. and a melting point Tm of less than or equal to 280° C.,
   and with
said polyamide polymer and its prepolymer a) comprising in their structure different amide units A and B and optionally amide units C and D, selected as follows:
   A: is a major amide unit present in a molar content ranging from 55% to 95%, preferably from 55% to 85%, more preferentially from 55% to 80%, chosen from units x.T, where x is a linear aliphatic C₉ to C₁₈ diamine, preferably C₉, C₁₀, C₁₁ and C₁₂ and in which T is terephthalic acid,
   B: is an amide unit different from A, said unit B being present in a molar content ranging from 5% to 45%, preferably from 15% to 45%, more preferentially from 20% to 45%, depending on the Tm of the polyamide based on unit A and said amide unit B is chosen from x′.T units where x′ is chosen from:
      B1) a branched aliphatic diamine bearing a single methyl or ethyl branch (or branching) and having a main chain length different by at least two carbon atoms relative to the main chain length of the diamine x of said associated unit A, preferably x′ being 2-methylpentamethylenediamine (MPMD) or
      B2) m-xylylenediamine (MXD) or
      B3) a linear aliphatic C₄ to C₁₈ diamine when, in the unit A, said diamine x is a linear aliphatic C₁₁ to C₁₈ diamine and x′ is a C₉ to C₁₈ diamine when, in the unit A, said diamine x is a C₉ or C₁₀ diamine,
         and preferably B being chosen from x′.T, where x′ is MPMD according to B1) or MXD according to B2) or a linear aliphatic diamine as defined above according to B3) and more preferentially x′ is MPMD according to B1) or MXD according to B2) and even more preferentially MXD according to B2),
C: optional amide unit different from A and than B, chosen from amide units based on a cycloaliphatic and/or aromatic structure or based on x′T as defined above for B but with x′ different from x′ for the unit B,
D: optional amide unit different from A, B and C when C is present and chosen from aliphatic amide units derived from:
   C₆ to C₁₂, preferably C₆, C₁₁ and C₁₂ amino acids or lactams or mixtures thereof
   the reaction of a linear aliphatic C₆ to C₁₈, preferably C₆ to C₁₂ diacid and of a linear aliphatic C₆ to C₁₈, preferably C₆ to C₁₂ diamine, or mixtures thereof
      and under the condition that the sum of the molar contents of A+B+C+D is equal to 100%.

The sum of the molar contents in the absence of C and D amounts to A+B=100%, with A and B making it up to 100%. If C is present without D, in this case this sum amounts to A+B+C=100%. If only D is present without C, said sum of 100% corresponds to A+B+D.

Said composition is more particularly a composition for a thermoplastic composite material and, in this case, it comprises said fibrous reinforcement, preferably based on long fibers. The term composition “for a thermoplastic composite material” means that

According to a first possibility in said molding composition of the invention, said prepolymer polyamide a), but also the polyamide polymer derived by polyaddition of said prepolymer a) with said extender b), comprises said amide unit according to C, different from A and B in which the unit C as defined above is present and in partial replacement for B and in a molar content ranging up to 25%, preferably up to 20% and more preferentially up to 15% relative to said unit B.

When the unit C is present and corresponds to x′T with x′ as defined above for the unit B, in this case C being different from B by definition, said unit C can be based on x′ which is defined according to B1) and in this case, said unit B may have x′ defined according to either B2) or B3). If C is based on x′ according to B2), in this case the unit B may be based on x′ which is according to B1) or B3). If C is based on x′ according to B3), in this case the unit B may be based on x′ which is defined according to B1) or B2).

More particularly, in this unit C of said composition, said aromatic structure may be chosen for example from the isophthalic and/or naphthalenic structure. A terephthalic structure is possible in particular for the diacid component when the diamine is cycloaliphatic. Said cycloaliphatic structure may be chosen from a structure based on a cyclohexane ring or a structure based on a decahydronaphthalenic ring (hydrogenated naphthalenic structure).

Preferably, the structure of C is derived from an aliphatic diamine and from a cycloaliphatic and/or aromatic diacid, for example as defined above, or from a diacid and from a cycloaliphatic diamine, for example as defined above. More particularly, said unit C is chosen from the units derived:
from a cycloaliphatic diamine and from terephthalic acid or
from a diacid chosen from isophthalic acid and naphthenic acid or based on cyclohexane and on a diamine x or x′ as defined above for the units A and B respectively.

According to another variant of the composition of the invention, said unit D is present and in partial replacement for B in a molar content that may be up to 70%, preferably up to 15% relative to said unit B. Thus, according to this variant, said composition comprises said unit D as defined above, in particular chosen from: C₆ to C₁₂) preferably C₆, C₁₁ and C₁₂, amino acids or lactams, or mixtures thereof, or units derived from the reaction of a C₆ to C₁₈, preferably C₆ to C₁₂, linear aliphatic diacid and of a C₆ to C₁₈, preferably C₆ to C₁₂, linear aliphatic diamine, and preferably with the units A and B being respectively based on the diamines x and x′ as defined above. Preferably, unit C and/or D, when it is present, partially replaces unit B with a molar content (C+D) up to 70% and preferably less than 40% relative to the molar content of said unit B as defined according to the invention. Thus, part of the unit B as defined according to the invention, which represents less than 50 mol % and preferably less than 40 mol % relative to B, may be replaced with a unit C and/or D as defined above according to the invention.

More particularly, the difference Tm−Tc, between the melting point Tm and the crystallization temperature Tc of said semi-crystalline thermoplastic polymer (polyamide), does not exceed 50° C., preferably does not exceed 40° C., and more particularly does not exceed 30° C.

In particular, Tm−Tc does not exceed 30° C. unless Tm−Tg is less than 150° C., in which case Tm−Tc may be up to 50° C.

According to a particular option, the heat of crystallization of said matrix polymer, measured by differential scanning calorimetry (DSC) according to standard ISO 11357-3, is greater than 40 J/g, preferably greater than 45 J/g.

Preferably, said amide unit A, as defined according to the invention above and below, is present in a molar content ranging from 55% to 80%, preferably from 55% to 75%, more preferentially from 55% to 70%, relative to all of the units of said matrix polymer (polyamide) as defined above according to the invention.

According to a first preferred option of the composition according to the invention described above, said composition has a unit B which corresponds to x′T with x′ defined according to option B1) described above, in particular with MPMD being a more preferred diamine for said unit B. Unit A remains as defined above, i.e. x.T, with x a C₉ to C₁₈, preferably C₉, C₁₀, C₁₁ or C₁₂, linear aliphatic diamine.

According to a second preferred option of said composition, it has a unit B which corresponds to x′ T where x′ is MXD (m-xylylenediamine) according to option B2) defined above. The unit A remains as defined for the first option mentioned. This second option constitutes, together with the first mentioned above, the options that are the most preferred of the invention and in particular this second option is the most preferred of the invention.

A third preferred option is that where B is defined according to option B1) or B2) or B3) as defined above and with the presence of a unit C as defined above as a replacement for B and up to 25 mol %, preferably up to 20 mol %, more preferentially up to 15 mol %, and in particular with B being defined according to the first or second option as defined above.

Even more preferentially, said polyamide composition is based on the units A and B selected as follows:
for the unit A which is 9T, said unit B is selected from: 10T, 11T, 12T, 13T, 14T, 15T, 16T, 17T and 18T, MPMD.T and MXD.T, preferably 11T, 12T, 13T, 14T, 15T, 16T, 17T and 18T, MPMD.T and MXD.T, more preferentially MPMD.T or MXD.T, with a molar content of B ranging from 30% to 45%,
for the unit A which is 10T, said unit B is selected from: 9T, 11T, 12T, 13T, 14T, 15T, 16T, 17T and 18T, MPMD.T and MXD.T, preferably 12T, 13T, 14T, 15T, 16T, 17T and 18T, MPMD.T and MXD.T, more preferentially MPMD.T or MXD.T, with a molar content of B ranging from 25% to 45%,
for the unit A which is 11T, said unit B is selected from: 9T, 10T, 12T, 13T, 14T, 15T, 16T, 17T and 18T, MPMD.T and MXD.T, preferably 9T, 13T, 15T, 16T, 17T and 18T, MPMD.T and MXD.T, more preferentially MPMD.T or MXD.T, with a molar content of B ranging from 20% to 45%,
for the unit A which is 12T, said unit B is selected from: 9T, 10T, 11T, 13T, 14T, 15T, 16T, 17T and 18T, MPMD.T and MXD.T, preferably 9T, 10T, 14T, 15T, 16T, 17T and 18T, MPMD.T and MXD.T, more preferentially MPMD.T or MXD.T, with a molar content of B ranging from 20% to 45%.

According to this selection, a first more particular composition of the invention can be defined with unit A being a unit 9T and unit B being selected from: 10T, 11T, 12T, 13T, 14T, 15T, 16T, 17T and 18T, MPMD.T and MXD.T, preferably 11T, 12T, 13T, 14T, 15T, 16T, 17T and 18T, MPMD.T and MXD.T, more preferentially MPMD.T or MXD.T, with a molar content of B ranging from 30% to 45%. A second particular composition corresponds to a unit A which is a unit 10T, unit B being selected from: 9T, 11T, 12T, 13T, 14T, 15T, 16T, 17T and 18T, MPMD.T and MXD.T, preferably 12T, 13T, 14T, 15T, 16T, 17T and 18T, MPMD.T and MXD.T, more preferentially MPMD.T or MXD.T, with a molar content of B ranging from 25% to 45%. A third particular composition corresponds to a unit A which is a unit 11T, unit B being selected from: 9T, 10T, 12T, 13T, 14T, 15T, 16T, 17T and 18T, MPMD.T and MXD.T, preferably 9T, 13T, 15T, 16T, 17T and 18T, MPMD.T and MXD.T, more preferentially MPMD.T or MXD.T, with a molar content of B ranging from 20% to 45%. Finally, another particular composition corresponds to a unit A which is a unit 12T, the unit B being selected from: 9T, 10T, 11T, 13T, 14T, 15T, 16T, 17T and 18T, MPMD.T and MXD.T, preferably 9T, 10T, 14T, 15T, 16T, 17T and 18T, MPMD.T and MXD.T, more preferentially MPMD.T or MXD.T, with a molar content of B ranging from 20% to 45%.

The number-average molecular weight Mn of said final (polyamide) polymer of the thermoplastic matrix of said composition is preferably in a range of from 10 000 to 40 000, preferably from 12 000 to 30 000. These Mn values can correspond to inherent viscosities greater than or equal to 0.8. As regards the number-average molecular mass Mn of said polyamide prepolymer a), it is at least two times smaller than that of the final polymer derived from said prepolymer a), said polymer constituting the thermoplastic matrix of a thermoplastic composite material in the case of the presence of a fibrous reinforcement. More particularly, the Mn of said prepolymer a) may range from 500 to 10 000, preferably from 1000 to 6000.

The semi-crystalline structure of said semi-crystalline polyamide polymer is essentially provided by the structure of said prepolymer a) which is also semi-crystalline.

Said extender b) may be selected from optionally substituted aliphatic, cycloaliphatic or aromatic diepoxides.

As examples of aliphatic diepoxides, mention may be made of aliphatic diol diglycidyl ethers, as aromatic diepoxides, mention may be made of bisphenol A diglycidyl ethers such as bisphenol A diglycidyl ether (BADGE) and, as cycloaliphatic diepoxides, mention may be made of cycloaliphatic diol or hydrogenated bisphenol A diglycidyl ethers. More generally, as examples of diepoxides that are suitable for use according to the invention, mention may be made of bisphenol A diglycidyl ether (BADGE), and its (cycloaliphatic) hydrogenated derivatives bisphenol F diglycidyl ether, tetrabromo bisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether of Mn<500, polypropylene glycol diglycidyl ether of Mn<500, polytetramethylene glycol diglycidyl ether of Mn<500, resorcinol diglycidyl ether, neopentyl glycol diglycidyl ether, bisphenol A polyethylene glycol diglycidyl ether of Mn<500, bisphenol A polypropylene glycol diglycidyl ether of Mn<500, diglycidyl esters of a dicarboxylic acid, such as terephthalic acid glycidyl ester, or epoxidized diolefins (dienes) or fatty acids with a double epoxidized ethylenic unsaturation, diglycidyl 1,2-cyclohexanedicarboxylate, and mixtures of the diepoxides mentioned.

Advantageously, when the identical reactive end functions X of said prepolymer are —CO2H, a catalyst specific for the esterification reaction may be used.

Such catalysts are generally acid or base catalysts. Such catalysts are known to those skilled in the art and may be found, for example, in “Epoxy Resins, Chemistry and Technology”, second edition, published by C.A. May, Marcel Dekker, New York, 1988.

By way of example, suitable catalysts that may be mentioned include the following:
imidazoles, such as 2-methylimidazole or 1,2-dimethylimidazole,
quaternary ammonium salts, such as tetramethylammonium salts, in particular tetramethylammonium acetate, tetramethylammonium chloride or tetramethylammonium bromide, or tetrabutylammonium salts such as tetrabutylammonium acetate, tetrabutylammonium chloride or tetrabutylammonium bromide, or benzyltriethylammonium salts such as benzyltriethylammonium acetate, benzyltriethylammonium chloride or benzyltriethylammonium bromide,
phosphines, such as triphenylphosphine,
tertiary amines, such as benzyldimethylamine or 2,4,6-tris(dimethylaminomethyl)phenol (under the name Ancamine® K54),
strong acids such as para-toluenesulfonic acid,
metal salts, such as zinc acetate, zinc acetylacetonate or zirconium acetylacetonate.

The amount of catalyst used in the compositions of the invention may range from 0.01 mol % to 10 mol % total of epoxy contained in the chain extender Y-A′-Y.

Preferably, the ratio between acid groups X and epoxy groups Y is from 0.9 to 1.0 and preferably 1.0.

More particularly, said reactive molding composition comprises, in addition to said precursor reactive composition, at least one fibrous reinforcement, preferably based on long fibers, in particular having a circular cross-section with L/D>1000, preferably >2000 and more particularly selected from glass fibers, carbon fibers, ceramic fibers and aramid fibers, or mixtures thereof.

The second subject of the invention relates to a process for manufacturing a thermoplastic composite material, in particular a mechanical part or a structural part based on at least one composition as defined according to the invention, said process comprising a step of melt impregnation of at least one fibrous reinforcement with a precursor reactive composition as defined above according to the invention, in an open mold or in a closed mold or not in a mold.

More particularly, said process comprises the following steps:
i) melt impregnation of a fibrous reinforcement with a precursor reactive composition as defined above according to the invention, in an open or closed mold or not in a mold, in order to obtain a molding composition with a fibrous reinforcement as defined above according to the invention,
ii) heating of the composition from step i) with bulk melt polyaddition polymerization reaction between components a) and b) of said precursor reactive composition,
iii) processing by molding or via another processing system, simultaneously with the polymerization step ii).

According to one option, the process of the invention comprises, simultaneously or after an interval, a processing step comprising molding and final forming of said impregnated fibrous reinforcement from step i) to form the final composite part in a mold.

Even more particularly, in said process, said processing is performed according to an RTM (resin transfer molding), compression injection molding or pultrusion technique or by infusion.

More particularly, during the melt impregnation, the viscosity of said precursor reactive composition remains at the impregnation temperature below 100 Pa.s and preferably <50 Pa.s.

The melt viscosity of said precursor reactive composition or of the prepolymer a) or of the polymer is measured according to the reference manual of the constructor of the measuring instrument used, which is a Physica MCR301 Rheometer, under nitrogen flushing at the temperature given under a shear of 100 s⁻¹, between two parallel planes 50 mm in diameter.

The Mn of the prepolymer a) or of the thermoplastic polymer is determined from titration (assay) of the end functions X according to a potentiometric method (back-assay of a reagent in excess relative to the OH end functions and direct assay for NH₂ or carboxyl) and from the theoretical functionality n calc (versus X) calculated from the material balance and from the functionality of the reactants (see the general calculation method in the description).

Measurement of the intrinsic or inherent viscosity is performed in m-cresol. The method is well known to those skilled in the art. Standard ISO 937 is followed, but with the solvent being changed (use of m-cresol instead of sulfuric acid, and the temperature being 20° C.).

The glass transition temperature Tg of the thermoplastic polymers used is measured using a differential scanning calorimeter (DSC), after a second heating cycle, according to standard ISO 11357-2. The heating and cooling rate is 20° C./min.

The melting point Tm and the crystallization temperature Tc are measured by DSC, after a first heating, according to standard ISO 11357-3. The heating and cooling rate is 20° C./min.

The heat of crystallization of said matrix polymer is measured by differential scanning calorimetry (DSC) according to standard ISO 11357-3.

The invention also covers said precursor reactive composition as defined above, which comprises said prepolymer reactive components a) and extender b) as defined above.

Next, the invention covers the use of said precursor composition as defined above (in the absence of fibrous reinforcement) for the melt impregnation of a fibrous reinforcement, as a precursor for the thermoplastic polymer matrix, for the manufacture of mechanical or structural parts based on composite material. More particularly, said mechanical or structural parts of said composite material concern applications in the motor vehicle, railway, marine or maritime, wind power or photovoltaic field, the solar energy field, including solar panels and components of solar power stations, the sports, aeronautical and aerospace fields, the road transport field regarding trucks, and the construction, civil engineering, panel, leisure, electrical or electronic fields. Depending on the final use of said parts, the Tg of the semi-crystalline polyamide thermoplastic polymer matrix according to the invention may be adapted to the needs. In particular, when the use concerns applications in the wind power field, the Tg of said polyamide is at least 80° C. and preferably at least 90° C. When it concerns applications in the motor vehicle field, the Tg of said polyamide polymer is at least 100° C. and when it concerns applications in the aeronautical field, the Tg of said polyamide polymer is at least 120° C.

Finally, the invention also relates to a molded part which results from the use of at least one molding composition without fibrous reinforcement or of a precursor reactive composition as defined above according to the invention. More particularly, it is a part made of composite material obtained from a composition comprising, in addition to said precursor reactive composition, at least one fibrous reinforcement based on long fibers, in particular having a circular cross-section with LID (length L to diameter D)>1000, preferably >2000 and more particularly selected from glass fibers, carbon fibers, ceramic fibers and aramid fibers, or mixtures thereof.

### EXAMPLES

Characterization Methods

The viscosity at 280° C. is measured according to the reference manual of the constructor of the measuring instrument used, which is a Physica MCR301 Rheometer, under nitrogen flushing at the temperature given under a shear of 100 sr⁻¹, between two parallel planes 50 mm in diameter.

The Mn of the prepolymer is determined by titration (assay) of the COOH end functions according to a potentiometric method and from a theoretical functionality of 2.

The glass transition temperature Tg is measured using a differential scanning calorimeter (DSC), after a second heating cycle, according to standard ISO 11357-2. The heating and cooling rate is 20° C./min.

The melting point Tm and the crystallization temperature Tc are measured by DSC, after a first heating, according to standard ISO 11357-3. The heating and cooling rate is 20° C./min.

The heat of crystallization is measured by differential scanning calorimetry (DSC) according to standard ISO 11357-3.

### A Preparation of the Reactive Prepolymer

This procedure is representative of all the types of polyamide of the invention. 5 kg of the following starting materials are placed in a 14 liter autoclave reactor:
500 g of water,
the diamines,
the diacid(s),
35 g of sodium hypophosphite in solution,
0.1 g of a Wacker AK1000 antifoam (the company Wacker Silicones).

The nature and mole ratio of the molecular units and structures of the reactive prepolymer polyamide are given in table 1 below.

The closed reactor is purged of its residual oxygen and then heated at a temperature of 230° C. of the material. After stirring for 30 minutes under these conditions, the pressurized vapor that has formed in the reactor is gradually reduced in pressure over the course of 60 minutes, while at the same time gradually increasing the temperature of the material such that it becomes established at a minimum at Tm+10° C. at atmospheric pressure, i.e. about 285° C.

The prepolymer is then emptied out via the bottom valve and then cooled in a water bath and then ground.

The characteristics of the prepolymer are presented in table 1 below.

TABLE 1
Characteristics of the prepolymer prepared

| Molecular | | | | | | | | | |
|---|---|---|---|---|---|---|---|---|---|
| structure and | | | | | | | Viscosity at | Acid | Mn |
| molar | | | Tm | Tg | Tm − Tc | ΔH | 280° C. | number | potentiometry |
| composition | Monomers used | X | (° C.) | (° C.) | (° C.) | (J/g) | (Pa · s) | mEq/kg(*) | g/mol |
| MXD · T/10 · T | m- | —CO₂H | 270.3 | 119.4 | 240.8 | 50.1 | 4.51 | 920 | 2173 |
| (41.2/58.8) | xylylenediamine | | | | | | | | |
| | decanediamine | | | | | | | | |
| | terephthalic | | | | | | | | |
| | acid | | | | | | | | |

(*)Milliequivalents per kilogram

B Preparation of the Polyamide Polymer by Chain Extension with an Extender Y-A′-Y with Y=Epoxy

The prepolymer described above after drying and grinding is mixed with a certain amount of diepoxide. The amount or proportion of each product is calculated so that the acid/epoxy stoichiometry is respected (1/1) and so that the total mass is equal to 12 g.

The mixture is introduced under nitrogen flushing into a DSM brand co-rotating conical screw microextruder (15 ml volume) preheated to 280° C., as defined in the invention, with rotation of the screws at 100 rpm. The mixture is left to recirculate in the microextruder and the increase in viscosity is monitored by measuring the normal force indicated by the machine. After approximately 10 minutes, a plateau is reached and the contents of the microextruder are emptied out in the form of a rod. The air-cooled product is formed into granules.

TABLE 2
Examples performed

| | | | | Final |
|---|---|---|---|---|
| | | | mol % of | normal |
| | | | catalyst (mol | force |
| | Diepoxide Y-A′-Y | Catalyst | catalyst/mol | measured |
| Ref | used | used | —CO₂H) | (N) |
| E1 | DER332 (bisphenol A | None | 0 | 4500 |
| | diglycidyl ether) | | | |
| E2 | DER332 (bisphenol A | 2-Methyl- | 5 | 4700 |
| | diglycidyl ether) | imidazole | | |
| E3 | Diglycidyi-1,2- | None | 0 | 2000 |
| | cyclohexane dicarboxylate | | | |

TABLE 3
Characteristics of the examples performed

| | Viscosity | Tm | Tg | Tc | Tm − Tc | ΔH |
|---|---|---|---|---|---|---|
| Ref | (Pa · s) | (° C.) | (° C.) | (° C.) | (° C.) | (J/g) |
| E1 | 5124 | 263.1 | 130.4 | 220.9 | 42.2 | 36.1 |
| E2 | 5419 | 268.1 | 131.9 | 226.2 | 41.9 | 42.2 |
| E3 | 1805 | 269.3 | 133.6 | 230.4 | 38.9 | 46.9 |

1. A reactive molding composition comprising a precursor reactive composition of a semi-crystalline thermoplastic polymer which is a semi-crystalline polyamide and optionally at least one fibrous reinforcement wherein:
said precursor reactive composition of said polyamide thermoplastic polymer comprises:
a) at least one thermoplastic polyamide prepolymer, bearing n identical reactive end functions X, chosen from: —NH₂ and —CO₂H, with n being from 1 to 3, and
b) at least one chain extender Y-A′-Y, with A′ being a single bond linking the two functions Y or a hydrocarbon-based diradical of non-polymeric structure, bearing 2 reactive epoxy end functions Y, reactive by polyaddition with at least one function X of said prepolymer a),
said semi-crystalline polyamide polymer derived from the polyaddition reaction between said components a) and b) of said precursor composition has a glass transition temperature Tg of at least 80° C. and a melting point Tm of less than or equal to 280° C., and
said polyamide polymer and its prepolymer a) comprise in their structure different amide units A and B and optionally amide units C and D, selected as follows:
A: is a major amide unit present in a molar content ranging from 55% to 95%, chosen from units x.T, where x is a linear aliphatic C₉ to C₁₈ diamine, and in which T is terephthalic acid,
B: is an amide unit different from A, said unit B being present in a molar content ranging from 5% to 45%, depending on the Tm of the polyamide based on unit A and said amide unit B is chosen from x′.T units where x′ is chosen from:
B1) a branched aliphatic diamine bearing a single methyl or ethyl branch (or branching) seems and having a main chain length different by at least two carbon atoms relative to the main chain length of the diamine x of said associated unit A, or
B2) m-xylylenediamine (MXD) or
B3) a linear aliphatic C₄ to C₁₈ diamine when, in the unit A, said diamine x is a linear aliphatic C₁₁ to C₁₈ diamine and x′ is a C₉ to C₁₈ diamine when, in the unit A, said diamine x is a C₉ or C₁₀ diamine,
C: optional amide unit different from A and than B, chosen from amide units based on a cycloaliphatic and/or aromatic structure or based on x′T as defined above for B but with x′ different from x′ for the unit B,
D: optional amide unit different from A, B and C when C is present and chosen from aliphatic amide units derived from:
C₆ to C₁₂ amino acids or lactams or mixtures thereof
the reaction of a linear aliphatic C₆ to C₁₈, diacid and of a linear aliphatic C₆ to C₁₈ diamine, or mixtures thereof,
and under the condition that the sum of the molar contents of A+B+C+D is equal to 100%.

2. The composition as claimed in claim 1, wherein amide unit C is present and in partial replacement for B in a molar content ranging up to 25% relative to said unit B.

3. The composition as claimed in claim 1, wherein unit D is present and in partial replacement for B in a molar content ranging up to 70% relative to said unit B.

4. The composition as claimed in claim 1, wherein the difference Tm−Tc, between the melting point Tm and the crystallization temperature Tc of said semi-crystalline thermoplastic polymer, does not exceed 50° C.

5. The composition as claimed in claim 1, wherein the heat of crystallization of said matrix polymer, measured by differential scanning calorimetry (DSC) according to standard ISO 11357-3, is greater than 40 J/g.

6. The composition as claimed in claim 1, wherein amide unit A is present with a molar content ranging from 55% to 80%, relative to all of the units of said polymer.

7. The composition as claimed in claim 1, wherein unit B corresponds to x′T with x′ chosen according to option B1).

8. The composition as claimed in claim 1, wherein unit B corresponds to x′T with x′ chosen according to option B2).

9. The composition as claimed in claim 1, wherein unit B corresponds to x′T with x′ being a linear aliphatic diamine as defined according to option B3).

10. The composition as claimed in claim 1, wherein units A and B are selected as follows:
for the unit A which is 9T, said unit B is selected from: 10T, 11T, 12T, 13T, 14T, 15T, 16T, 17T and 18T, MPMD.T and MXD.T, with a molar content of B ranging from 30% to 45%
for the unit A which is 10T, said unit B is selected from: 9T, 11T, 12T, 13T, 14T, 15T, 16T, 17T and 18T, MPMD.T and MXD.T, with a molar content of B ranging from 25% to 45%
for the unit A which is 11T, said unit B is selected from: 9T, 10T, 12T, 13T, 14T, 15T, 16T, 17T and 18T, MPMD.T and MXD.T, with a molar content of B ranging from 20% to 45%
for the unit A which is 12T, said unit B is selected from: 9T, 10T, 11T, 13T, 14T, 15T, 16T, 17T and 18T, MPMD.T and MXD.T, with a molar content of B ranging from 20% to 45%.

11. The composition as claimed in claim 10, wherein unit A is a unit 9T and the unit B is selected from: 10T, 11T, 12T, 13T, 14T, 15T, 16T, 17T and 18T, MPMD.T and MXD.T, with a molar content of B ranging from 30% to 45%.

12. The composition as claimed in claim 10, wherein unit A is a unit 10T and the unit B is selected from: 9T, 11T, 12T, 13T, 14T, 15T, 16T, 17T and 18T, MPMD.T and MXD.T, with a molar content of B ranging from 25% to 45%.

13. The composition as claimed in claim 10, wherein unit A is a unit 11T and the unit B is selected from: 9T, 10T, 12T, 13T, 14T, 15T, 16T, 17T and 18T, MPMD.T and MXD.T, with a molar content of B ranging from 20% to 45%.

14. The composition as claimed in claim 10, wherein unit A is a unit 12T and the unit B is selected from: 10T, 11T, 13T, 14T, 15T, 16T, 17T and 18T, MPMD.T and MXD.T, with a molar content of B ranging from 20% to 45%.

15. The composition as claimed in claim 7, wherein unit C and/or D as defined in claim 1 partly replaces unit B with a molar content of up to 70%, relative to the molar content of said unit B.

16. The composition as claimed in claim 1, wherein reactive prepolymers a) have a number-average molecular mass Mn ranging from 500 to 10 000.

17. The composition as claimed in claim 1, wherein extender is an optionally substituted aliphatic, cycloaliphatic or aromatic diepoxide.

18. The composition as claimed in claim 1, wherein the composition comprises at least one fibrous reinforcement.

19. A process for manufacturing a thermoplastic composite based on at least one composition as defined according to claim 1, wherein the composition comprises a step of melt impregnation of at least one fibrous reinforcement with a precursor reactive composition as defined above, in an open mold or in a closed mold or not in a mold.

20. The process as claimed in claim 19, comprising the following steps:
i) melt impregnation of a fibrous reinforcement with a precursor reactive composition as defined above, in an open or closed mold or not in a mold, in order to obtain a molding composition with a fibrous reinforcement as defined above,
ii) heating of the composition from step i) with bulk melt polyaddition polymerization reaction between components a) and b) of said precursor reactive composition, with chain extension, and
iii) processing by molding or via another processing system, simultaneously with the polymerization step ii).

21. The process as claimed in claim 20, comprising, simultaneously or after an interval, a processing step comprising molding and forming of said impregnated fibrous reinforcement from step i) to form the final composite part in a mold.

22. The process as claimed in claim 21, wherein processing is performed according to an RTM, compression injection molding or pultrusion technique or by infusion.

23. The precursor reactive composition as defined in claim 1, comprising prepolymer components a) and extender b).

24. The use of a precursor composition as defined in claim 1, in the absence of fibrous reinforcement), for the melt impregnation of a fibrous reinforcement, as a precursor for the thermoplastic polymer matrix, for the manufacture of mechanical or structural parts based on composite material.

25. The use as claimed in claim 24, wherein mechanical or structural parts of said composite material concern applications in the motor vehicle, railway, marine or maritime, wind power or photovoltaic field, the solar energy field, including solar panels and components of solar power stations, the sports, aeronautical and aerospace fields, the road transport field regarding trucks, and the construction, civil engineering, protective panel, leisure, electrical and electronic fields.

26. The use as claimed in claim 25, wherein the use concerns applications in the wind power field and in that the Tg of said polyamide is at least 80° C.

27. The use as claimed in claim 25, wherein the use concerns applications in the motor vehicle field and in that the Tg of said polyamide polymer is at least 100° C.

28. The use as claimed in claim 25, wherein the use concerns applications in the aeronautical field and in that the Tg of said polyamide polymer is at least 120° C.

29. A molded part, wherein part results from the use of at least one molding composition as defined according to claim 1.

30. The part as claimed in claim 29, wherein the part is made of composite material based on said composition as defined.
